(19) United States
(12) Patent Application Publication
(10) Pub. No.: US 2013/0001251 A1
(43) Pub. Date: Jan. 3, 2013

(54) BEVERAGE MACHINE USING INGREDIENT CAPSULES

(75) Inventor: Peter Mori, Walperswil (CH)

(73) Assignee: NESTEC S.A., Vevey (CH)

(21) Appl. No.: 13/635,293

(22) PCT Filed: Mar. 16, 2011
(86) PCT No.: PCT/EP2011/053948

§ 371 Date: Sep. 14, 2012

(30) Foreign Application Priority Data
Mar. 19, 2010 (EP) 10290148.5

(51) Int. Cl. A47J 31/44

(52) U.S. Cl. 222/83.5

(57) ABSTRACT

The invention concerns a beverage machine comprising a casing (32) enclosing: a first part (34) for receiving an ingredient capsule therein, a second part (70) having a surface (91) provided with perforating projecting members (90) facing the first part, an opening (76) in the casing enabling the capsule to be inserted in a direction of insertion (Z) between the first and second parts, the first and second parts being movable relative to each other along a longitudinal axis (X) perpendicular to surface (91) between a first position in which first and second parts are spaced apart so that the ingredient capsule is inserted therebetween and a second position in which first and second parts are close to each other so that the capsule is in contact with the member. The members (90) are provided in an arrangement on the surface with respect to the opening (76) so as to permanently reduce the risk of trapping of the capsule by the members during the capsule insertion.

The invention relates to a beverage machine using ingredient capsules containing food ingredients or substances for preparing a beverage or, to a larger extent, comestibles.

Machines using ingredient capsules are already known, for instance from WO2005/004683.

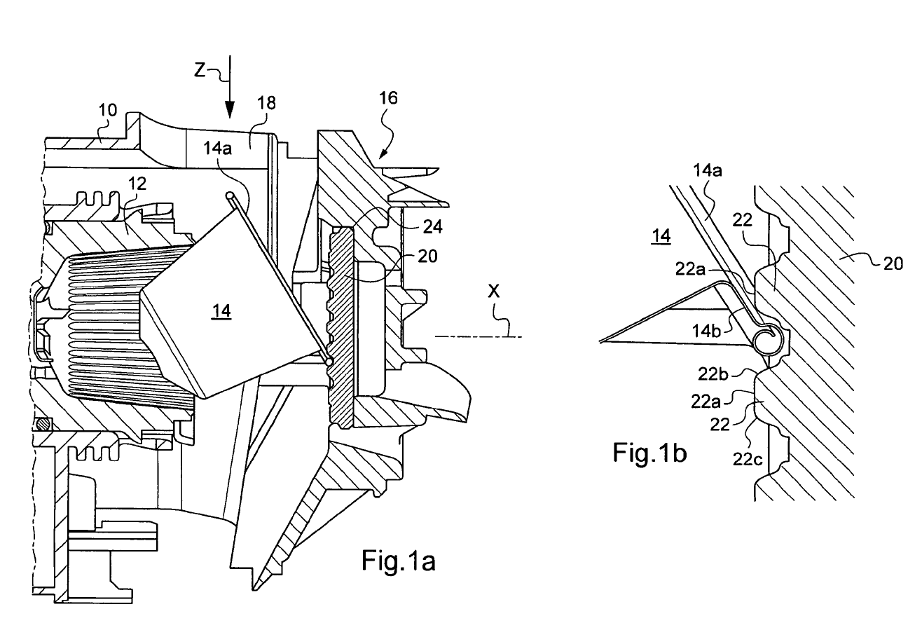

FIG. 1a schematically represents a machine of this type comprising a casing 10 enclosing:
a capsule cage 12 which is intended for receiving an ingredient capsule 14 therein, and
a vertical capsule holder 16.

A passage 18 is provided on the top of the casing to enable vertical introduction of an ingredient capsule inside the machine.

The capsule cage 12 is movable along a longitudinal horizontal axis X between two positions. In a first position the capsule cage is spaced apart from the capsule holder and an ingredient capsule can be introduced from above between the capsule holder and the capsule cage.

More particularly, the ingredient capsule is inserted through the passage and guided along the direction of insertion Z thanks to side guiding rails not represented in FIG. 1a. The capsule is maintained in an intermediate position between the capsule cage and the capsule holder through stops arranged in the two rails respectively.

In this intermediate position the ingredient capsule 14 is maintained slightly inclined by virtue of its center of gravity and is located slightly above the central axis of the vertical capsule holder.

When the capsule cage is further moved horizontally towards the capsule holder the ingredient capsule is urged to pass below the two stops so as to be pressed against the capsule holder along its central axis (second position). When the capsule cage moves backward the ingredient capsule falls by gravity in a lower collecting bin.

It is to be noted that an ingredient capsule 14 may be filled with ingredients such as roasted and grounded coffee and closed by a closing member such as a tear face cover 14a or membrane and/or filtering wall.

A lateral extension 14b of the capsule is formed from the side wall and thus forms a flange on which the closing member is fixed.

For preparing coffee beverage the tear face cover or membrane has to be torn when the ingredient capsule is located in the above-mentioned second position of the capsule cage and capsule holder.

An example of capsule holder is more particularly described in EP 0 512 470.

As described in EP 0 512 470 and represented in FIGS. 1a et 1b the capsule holder 16 comprises a plate 20 with relief surface element projecting members in the form of pyramids 22 and beverage evacuation orifices. The plate is accommodated in a seat 24 and is able to turn freely therein.

Each pyramid 22 has at its upper surface 22a four linear tear edges two of which only, 22b and 22c, being represented in profile in FIG. 1b. The tear face cover of the capsule presses against these edges under pressure residing in the capsule and tears and the coffee beverage flows through the filtration orifices.

The Applicant has noticed that the ingredient capsule 14 when vertically inserted through the top passage 18 may abut through its flange 14b against the pyramid-shaped projecting members 22 and more particularly against the tear edges of these members that are horizontally arranged (see for example the horizontal tear edges 22b and 22c in FIG. 1b).

This gives rise to a blockage of the ingredient capsule in an incorrect position as represented in FIGS. 1a and 1b.

Most often, the ingredient capsule abuts against the pyramid-shaped projecting members that are located in the lowest part of the plate and in the middle thereof as schematically represented in FIG. 1a.

When such a blockage occurs and the capsule cage comes closer to the capsule holder during a closing movement of the machine, the incorrectly positioned ingredient capsule is crushed, thereby hindering complete closure of the machine.

The Applicant has remedied this drawback by providing the capsule cage with a non completely horizontal movement. A small inclined ramp disposed on the path of the capsule cage enables engagement of the ingredient capsule with the capsule cage at a higher location than previously.

This higher engagement makes it possible to reduce the risk of blockage arising from the abutment of an ingredient capsule against the pyramid-shaped projecting members.

However, this arrangement makes the movement of the capsule cage as well as the mechanism of the machine more complex.

There is now a need for a new machine which does not need any ramp for overcoming the above-mentioned blockage issue.

There is also a need for a new simplified machine remedying the above-mentioned blockage issue.

There is a further need for a new machine in which the moving part that is either a first part enclosing an ingredient capsule or a second part having a perforating function follows a rectilinear path.

The present invention aims at fulfilling at least one of the above-mentioned needs and is directed to a beverage machine in accordance with claim 1.

Thus, the Applicant has discovered that the risk of trapping of the ingredient capsule in a non-desired position in the machine by the perforating projecting members during the insertion of the ingredient capsule in the machine can be permanently reduced by suitably arranging the perforating projecting members with respect to the opening.

It is to be noted that the opening defines the direction of insertion which is substantially perpendicular to the cross-section of the opening in its middle portion.

The appropriate arrangement of the perforating projection members on the surface depends on the shape and size of the members and on the space left free between them. The space left free between the perforating projecting members may be reduced to prevent the capsule from being trapped by predetermining a preferred orientation of the arrangement in the machine.

The risk of blockage is therefore reduced in an easy manner since it is no longer necessary to envisage a complex displacement of the mobile engaging part(s) in the machine. Also, opportunities for easier machine designs are further possible.

It is to be noted that the capsule beverage machine according to the invention provides reliable capsule handling with reduced risks of blockage during capsule insertion and closure.

This is because insertion of an ingredient capsule in the machine is more reliable than in the prior art existing machines.

According to one feature, the space left free by the perforating projecting members on the surface is dimensioned and/or oriented so as to reduce the risk of trapping of the ingredient capsule by the perforating projecting members during the insertion of the ingredient capsule.

When this space is too large and oriented perpendicularly to the insertion of direction, then trapping of the ingredient capsule may occur.

Thus, if this space is reduced, even though it is still oriented perpendicularly to the insertion of direction, then a risk of trapping of the ingredient capsule may be reduced.

If the space left free by the perforating projecting members on the surface is large enough to permit trapping of the ingredient capsule when oriented perpendicularly to the direction of insertion of the ingredient capsule, nevertheless orientating this space at an angle to the direction of insertion that is different from 90° may reduce the risk of trapping.

According to one feature, the perforating projecting members have each several perforating edges lying in a plane parallel to the surface of the second part, the perforating edges of the perforating projecting members which are oriented towards the opening being arranged at an angle to the insertion direction that is less than 90° when viewed in the plane where the perforating edges lie.

Thus, the perforating edges are suitably oriented with respect to the insertion direction so that the ingredient capsule cannot abut against these edges when inserted in the machine.

More particularly, the angle of orientation of the perforating edge is less than 75°.

Such a value enables further reduction of the risk of trapping of the ingredient capsule.

It is to be noted that the arrangement may be in the form of a grid. For instance, a grid comprises rows and columns both at 90° to each other.

However, other forms of arrangement may be envisaged.

According to one feature, the perforating projecting members are truncated pyramids extending each from a base connected to the surface to a free end that has a squared surface defined by four linear perforating edges.

Channels are thus formed between the members which are usually necessary for facilitating liquid (e.g. beverage) evacuation.

These shapes are suitable for tearing the closing member of the ingredient capsule when the beverage machine is operated.

According to another feature, the second part comprises a plate having the surface provided with the perforating projecting members, and that is able to rotate about an axis perpendicular to the surface, the machine comprising positioning means for positioning the surface in a predetermined angular position where the arrangement of the perforating projecting members enables permanent reduction of the risk of trapping of the ingredient capsule by the perforating projecting members during the insertion of the ingredient capsule.

These positioning means make it possible to orientate the surface with the perforating projecting members in an angular orientation which avoids, or at least reduces, the risk of trapping of the ingredient capsule.

These means may be used when the space left free by the perforating projecting members is not appropriately sized in any direction.

Thus, in order to prevent that the surface be orientated incorrectly, that is with the too large space orientated perpendicularly to the insertion direction of the ingredient capsule, then the surface is orientated differently so that the latter space be no longer perpendicular to the insertion direction.

Further, the positioning means may allow the surface to be slightly rotated around the predetermined angular position.

This slight rotation (rotation over a small angle of rotation) makes it possible to accommodate the same plates with perforating projecting members (perforating plates) within slightly different beverage machines.

According to another feature, the plate is mounted against a support and positioning means comprise male and female cooperating means on the support and the plate to prevent the plate from being significantly rotated from the predetermined angular position.

Such positioning means make it possible to avoid a rotation over too a large range.

This is because return of the plate to a position where the space left free by the perforating projecting members is orientated perpendicularly to the insertion direction and large enough to make it possible to trap the ingredient capsule is not desired.

According to another feature, the part selected among the first and second parts and that is movable relative to the other part is displaced according to a rectilinear path along the longitudinal axis.

Thus, the movement of the moving parts of the machine is easier than in the prior art existing machines where a ramp was necessary.

Thus, the brewing unit of the machine is constructed more easily than in the prior art existing machines given the rectilinear movement of the brewing unit.

According to a first embodiment, the first part of the machine that receives an ingredient capsule is mobile whereas the second part is in a fixed position.

However, in another embodiment, the first part of the machine receiving an ingredient capsule is in a fixed position whereas the second part is mobile relative to the first part.

According to the type of machine, one embodiment or the other may be implemented.

Another object of the invention is a set comprising a beverage machine and an ingredient capsule in accordance with claim 13.

Other aspects and features will be described in the course of the non limitative following description, given with reference to the accompanying drawings in which:

FIGS. 1a and 1b schematically and partly illustrate the issue of trapping of an ingredient capsule during its insertion in a prior art existing beverage machine;

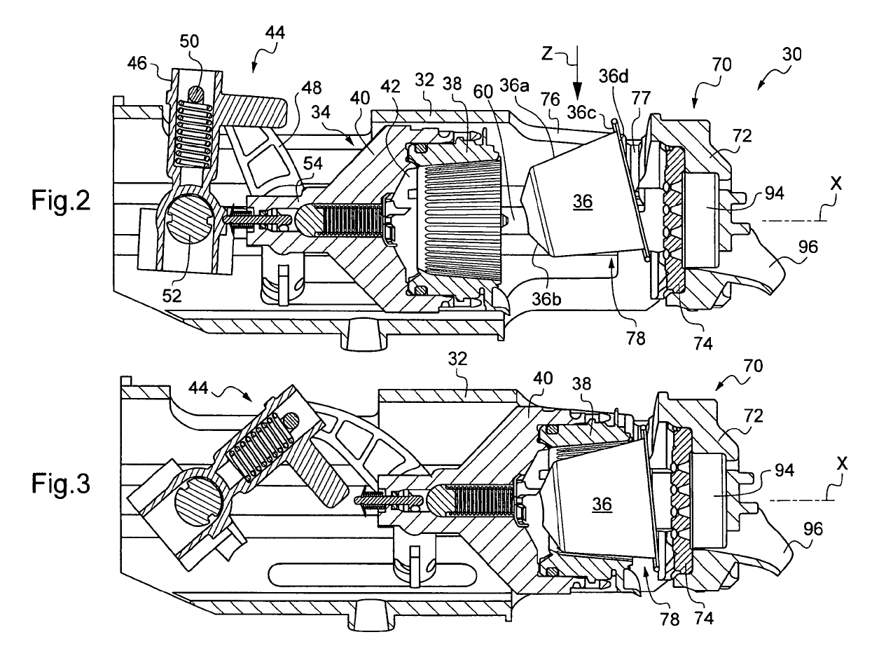

FIGS. 2 to 4 schematically represent a longitudinal cross-section of a beverage machine according to the invention showing successive steps of the machine when operated;

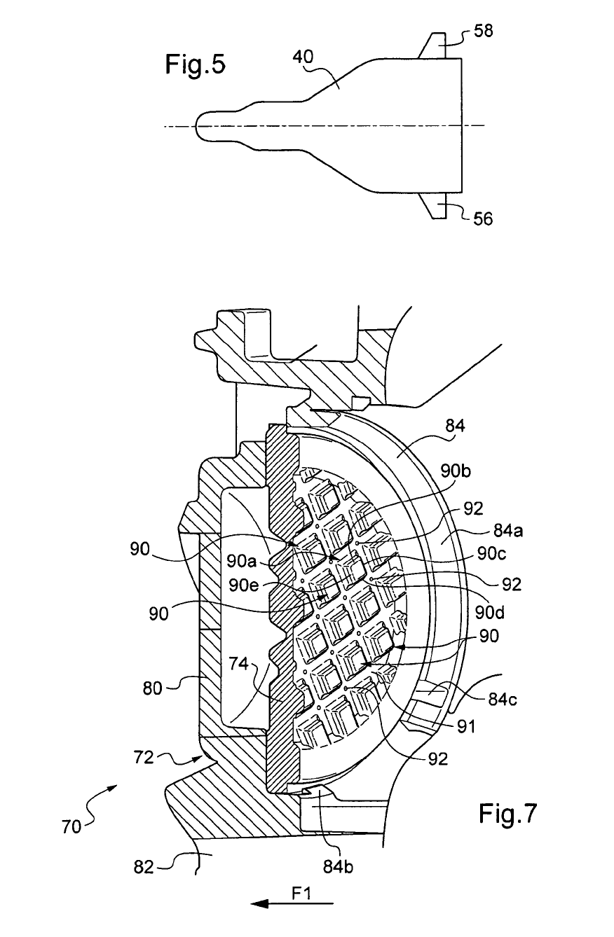

FIG. 5 is a schematic top view of the capsule enclosing member represented in FIG. 2;

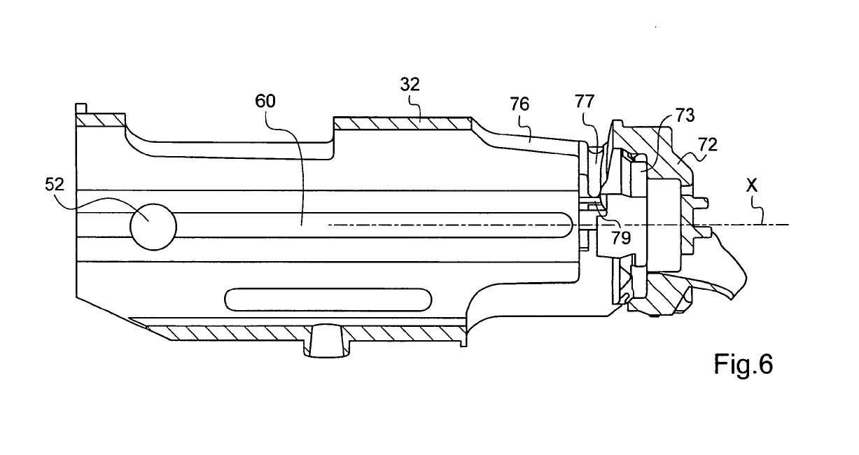

FIG. 6 is a longitudinal cross-section of casing 32 represented in FIGS. 2 to 4;

FIG. 7 is a partial schematic view in perspective of perforating plate 74 assembled in second part 70;

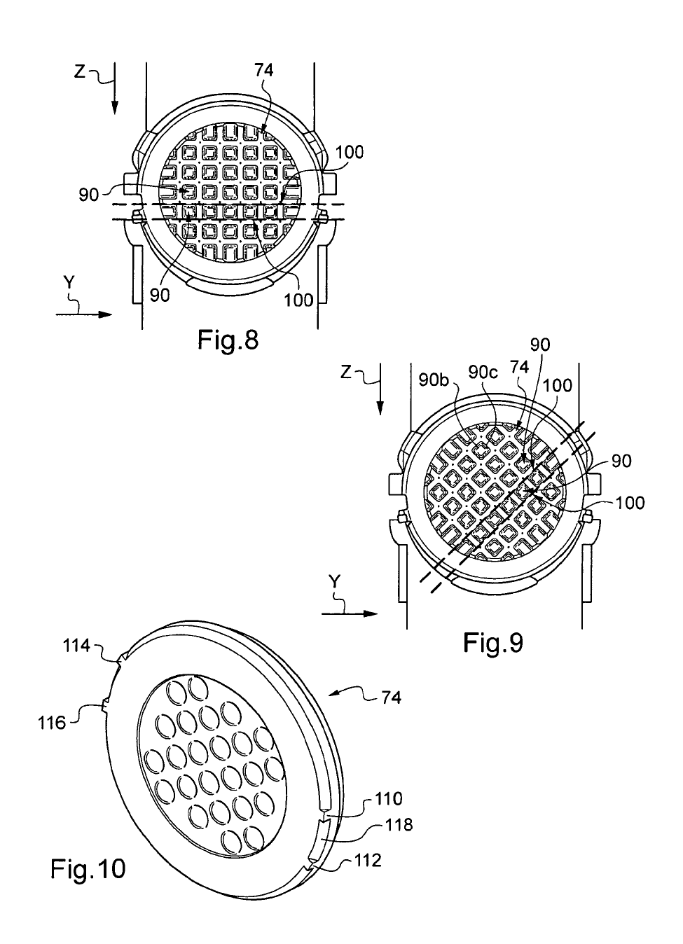

FIG. 8 is a schematic front view of a perforating plate in a prior art existing beverage machine;

FIG. 9 is a schematic front view of a perforating plate oriented in accordance with the invention;

FIG. 10 is a back view showing a perforating plate provided with indents in perspective;

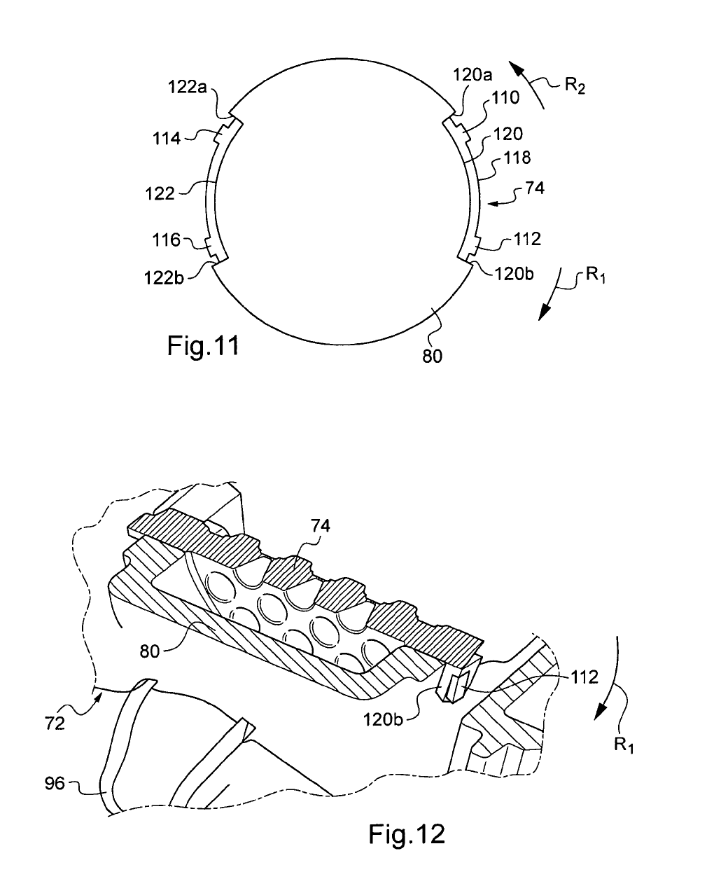

FIG. 11 is a back view showing a perforating plate and its supporting portion assembled in a superimposed manner;

FIG. 12 is a partial back view in perspective of a perforating plate assembled against its supporting portion and blocked in rotation.

As schematically represented in FIGS. 2 to 4, a beverage machine 30 comprises a casing 32 enclosing several components.

A first part of the machine denoted 34 is intended for receiving an ingredient capsule therein.

An ingredient capsule 36, also called cartridge, is represented in the drawings under the shape of a container having walls, in particular a side wall 36a and a bottom wall 36b.

The side wall 36a defines at its end opposite to the bottom wall an aperture enabling filling of the container with ingredients.

Such ingredients may be coffee, e.g. roasted and grounded coffee.

However, other ingredients such as substances or products or mixtures of ingredients substances or products which are suitable for preparing fluid comestibles by addition of water may be accommodated in the container.

These other ingredients include, in a non limitative way, tea, soluble tea or soluble coffee, a mixture of ground coffee and soluble coffee, cocoa, or a cocoa or chocolate-based or supplemented product including coffee, or a soup, or of foods such as in the form of infusions, for example.

A flange 36c extends laterally and outwardly from side wall 36a and surrounds the capsule aperture.

A closing member 36d closes the aperture. The closing member rests against the flange 36c and is tightly sealed thereto so as to seal the filled capsule.

The closing member is for example a tear face cover or a membrane which is to be torn during the extraction process as will be seen subsequently.

Alternatively, the closing member may be a filtering wall or filter.

Also, the closing member may be a combination of some of the preceding elements (e.g. a tear face cover and a filtering wall disposed close to each other).

As represented in the drawings the ingredient capsule has an overall frusto-conical shape. However, other less preferred forms may be envisaged within the scope of the invention such as a cylindrical shape.

The first part 34 includes a piston part 38 of a capsule enclosing member 40 having a recess 42 for accommodating piston part 38 therein.

The mechanism of the capsule enclosing member or cage 40 is more particularly detailed in EP 2 068 684.

A mechanism 44 is provided in the machine for imparting a longitudinal displacement along an horizontal axis X to first part 34.

Briefly, mechanism 44 includes two pairs of articulated rods, only two of which 46 and 48 being represented in the drawings.

The rods are linked together and articulated through a pivot shaft 50.

Rod 46 is also linked to a shaft 52 which is able to rotate about itself when a lever (not represented in the drawings) connected to shaft 52 is actuated by a user.

Rod 48 is linked to a shaft (not represented in the drawings) that is connected to capsule enclosing member 40 and for instance to the basis 54 of capsule enclosing member 40.

Shaft 52 and the shaft to which rod 48 is linked are arranged in alignment along longitudinal axis X.

As schematically represented in FIG. 5, capsule enclosing member 40 viewed from above is provided on its outer peripheral surface with two guiding members 56, 58 which are for instance two lugs. These members are disposed on opposite sides of body 40 and are engaged in two respective guiding slots provided in casing 32.

FIG. 6 represents the inner side of casing 32, all the components in FIG. 2 being removed therefrom except shaft 52.

Only one guiding slot 60 has been represented in this Figure, the other one (not represented in the drawings) being symmetrical with respect to a median plane containing longitudinal axis X.

Slot 60 (as well as the other symmetrical slot) has a longitudinal shape aligned with horizontal axis X and guiding member 56 is engaged in guiding slot 60 (as well as guiding member 58 in the other guiding slot).

When the lever is actuated by a user supporting body 40 and capsule cage 38 are moved along longitudinal axis X while guiding members 56 and 58 slide in the two guiding slots respectively (see FIG. 3).

Further, the shaft (not represented in the drawings) to which rod 48 is linked is also engaged in slot 60 for guiding supporting body 40 on its rectilinear path.

Other aspects and details relative to this part of the machine and in particular the moving mechanism can be found in WO 2005/004683.

The machine 30 further includes a second part 70, also called capsule holder, which is in a fixed position in this embodiment.

Alternatively, in another embodiment which is not represented in the drawings the first part of the machine receiving an ingredient capsule is in a fixed position, whereas the second part is mobile relative to the first part.

Such an arrangement is for example described in WO 2009/043630.

Second part 70 includes a capsule holding element 72 which defines a housing 73 (see FIG. 6) for accommodating a perforating plate 74 against which the ingredient capsule is to be placed at the end of the movement of first part 34.

An opening 76 is provided at the top of the casing close to second part 70.

This opening enables introduction of an ingredient capsule in a part of the machine called brewing chamber 78 and which is located between first part 34 and second part 70.

The ingredient capsule 36 is inserted in the casing through opening 76 in a direction of insertion Z (vertical direction) that is perpendicular to displacement axis X.

The machine further includes two symmetrical guiding members, e.g. two guiding rails, which are arranged along the Z direction on two opposite inner sides of the casing and extend from opening 76 downwards.

FIGS. 2 and 6 illustrate one of the two guiding members denoted 77, the second one (not represented in the drawings) being symmetrical with respect to a vertical plane containing longitudinal axis X.

When the ingredient capsule is introduced through opening 76 the flange of the capsule is inserted between the guiding members so as to be guided during its descending movement down to the position represented in FIG. 2 within brewing chamber 78.

More particularly, two diametrically opposite portions of the flange are respectively inserted in the two opposite guiding rails and slide in these rails. The dimensions of the rails and flange of the capsule are designed relative to one another in such a manner that the capsule becomes inclined with respect to the direction Z, in the intermediate position, as represented in FIG. 2. In particular, the width of each rail (transverse dimension with respect to insertion direction) is preferably greater than the thickness or height of flange 36c covered with closing member 36d.

The two guiding members include two stops respectively that are arranged on the path of the flange of the ingredient capsule.

The two stops, e.g. bumps, are respectively located in the two guiding rails at a height enabling abutment of the capsule against the stops in the intermediate position as represented in FIG. 2. The two stops reduce the width that is available in the brewing chamber for the flange to normally freely pass, thereby leading to abutment of the capsule flange against the stops.

FIG. 6 illustrates the stop denoted 79 that is located in guiding member 77.

FIG. 7 schematically and partly represents perforating plate 74 assembled in second part 70.

More particularly, holding element 72 comprises a central supporting portion 80 against which perforating plate 74 is to be placed and a peripheral portion 82 which extends axially from central portion 80 towards first part 34 of the machine, thereby defining a central housing for accommodating plate 74.

A ring member 84 radially extends from peripheral portion 82 inwardly at an axial distance from supporting portion 80.

Ring member 84 has an inside diameter slightly greater than the outside diameter of plate 74 and is provided with several inner elements on its inner face 84a. Only two of them 84b and 84c are represented in the drawing, whereas for example four elements may be peripherally located on the ring.

Such inner ring elements extend radially and inwardly from the inner face 84a and act each as a ramp for facilitating the introduction of perforating plate in its housing in a direction denoted by arrow F1 in FIG. 7.

The insertion through the opened central portion of ring 84 is made possible due to a relative elasticity between ring 84 and perforating plate 74.

When plate 74 is forcibly engaged through ring 84 in the position represented in FIG. 7 each inner ring element acts a retaining means in order to prevent plate 74 from being withdrawn in the opposite direction.

Perforating plate 74 is thus snapped fittingly in its housing or seat.

As represented in FIGS. 7 to 9, plate 74 comprises a plurality of perforating projecting members 90 extending from a surface 91 as well a plurality of beverage evacuation orifices 92 arranged therebetween.

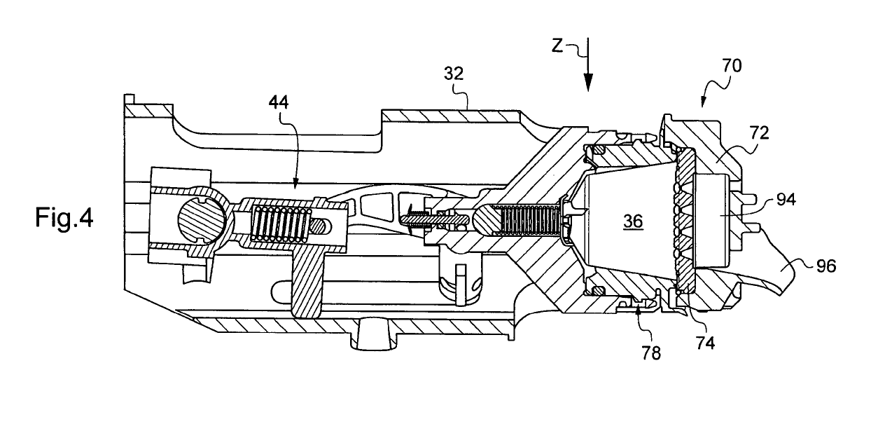

Briefly, in the position represented in FIG. 4 ingredient capsule 36 is close to the perforating projecting members 90 of plate 74, e.g. in contact with members 90, and hot water is injected into the capsule under a given pressure in a known manner.

Under the action of the pressure within the capsule the closing member 36d (e.g. a tear face or membrane) deforms and presses against the perforating projecting members 90, thereby leading to tearing of the closing member.

Fluid that is contained in the capsule (e.g. coffee) flows out of the capsule and is permitted to pass through beverage evacuation orifices 92 that open out in a receiving chamber 94 (FIG. 4).

Fluid flows from chamber 94 through an exit nozzle 96 and pours down into a cup not represented in the drawings.

Further details and aspects relative to extraction of fluid from the capsule are given in U.S. Pat. No. 5,402,707.

As represented in FIG. 7 and more fully described in U.S. Pat. No. 5,402,707, each perforating projecting member 90 has the overall shape of a truncated pyramid. The pyramid extends in an axial direction from a squared base 90a connected to surface 91 to a free end that has a squared surface defined by four linear perforating edges 90b, 90c, 90d and 90e.

The perforating edges lie in a plane parallel to surface 91 and tear the closing member of the ingredient capsule when the latter is pressed against the perforating members as already explained above.

According to other embodiments which are not illustrated here, the perforating projecting members may take other forms such as prisms, cylinders, or frustums of optionally polygonal or circular cross-section.

The Applicant has discovered that it is possible to reduce the risk of trapping of an ingredient capsule by the perforating projecting members during the insertion of the capsule as illustrated in FIGS. 1a and 1b by suitably arranging the perforating projecting members on the surface 91 with respect to opening 76 and the direction of insertion Z of the capsule.

In particular, the Applicant has noticed that if the perforating projecting members are too spaced apart from each other and/or are oriented in such a way that a space left free by the perforating projecting members in an orientation Y perpendicular to direction Z is too large, then trapping/blocking of the capsule against these members may occur.

The flange 36c of the capsule is also preferably designed with an enlarged end portion, e.g. curled or solid end, that is dimensioned and shaped to reduce its possible introduction in the space left free between the members when the capsule plate is properly oriented.

FIG. 8 illustrates in a reduced size compared to that of FIG. 7 projecting members 90 where the space left free between two consecutive members is small enough to reduce a risk of trapping/blocking of the capsule.

However, the horizontal and vertical orientation of the grid arrangement (members are arranged on the surface 91 so as to form between the members passages that are perpendicular to each other) makes it possible to accommodate a portion of the capsule flange in the horizontal passages 100 denoted by dotted lines (in direction Y) between the members 90 when the capsule is vertically inserted in Z vertical direction.

FIG. 9 illustrates an angular orientation of the array arrangement of the perforating projecting members 90 which makes no longer possible to trap the flange of the capsule in passages 100 when the capsule is inserted in Z direction.

Passages 100 are no longer horizontal since plate 74 has been rotated about an axis of rotation perpendicular to plate 74 over an angle of at least 15° with respect to the horizontal line and for example an angle equal to 45°.

Thus, the space left free by the perforating projecting members on surface 91 in the orientation Y perpendicular to the insertion direction Z has been considerably reduced compared to that existing in FIG. 8.

This space is thus appropriately dimensioned in the arrangement of FIG. 9 so as to reduce the risk of trapping of the capsule.

In other embodiments, the arrangement of the perforating members on the surface may be such that the space left free by these members is always small enough relative to the flange of the capsule to prevent trapping of the ingredient capsule, whatever the orientation of the space with respect to direction of insertion.

Thus, even though the perforating plate is mounted freely in rotation within its housing as in prior art existing machines risk of trapping is reduced.

It is to be noted that the perforating edges of the perforating projecting members which are oriented towards opening 76 (perforating edges 90b and 90c in FIG. 9) are arranged at an angle to the Z insertion direction that is less than 90° and preferably less than 75°.

This arrangement of the upwardly oriented perforating edges guarantees that the risk of trapping of an ingredient capsule is reduced.

The above also applies to perforating projecting members of other shapes, such as members with a triangular or diamond-shaped cross-section.

In addition, in order to further reduce the risk of trapping the relative dimensions between the thickness of the flange of the ingredient capsule and the space left free between the perforating projecting members may be adjusted in a suitable manner.

Thus, the thickness of the flange may be increased so as to be greater than the space left free between the perforating projecting members. It is therefore more difficult for the capsule flange to be trapped by the members.

Alternatively, or in a combination with the increased thickness, the dimensions of the space between the perforating projecting members may be reduced, thereby making more difficult trapping of the capsule flange by the members.

Furthermore, the Applicant has added specific means to the existing machines to permanently position or orientate the perforating plate 74 in a predetermined angular position, as for example that illustrated in FIG. 9.

Plate 74 and its supporting portion may be designed so that plate 74 cannot come back to the position of FIG. 8 through inadvertent rotation.

However, rotation of the plate may not be completely prevented and a slight rotation over a predetermined angular range around the predetermined angular position may be envisaged.

This slight rotation makes it possible to take into account different machines and perforating plates and facilitate the mounting of the latter on the former e.g. thanks to an automated device or robot.

For example, a magnitude of rotation of ±15° around the predetermined angular position is permitted.

FIGS. 10 to 12 illustrate positioning means for positioning plate 74 in the above-mentioned predetermined angular position. These means impart a given orientation to plate 74.

In particular, plate 74 is provided with male blocking members and the support of the machine against which plate 74 is mounted is provided with complementary female blocking members, thereby enabling cooperation of male and female members in order to position plate 74 in a given position. This position is different and spaced apart from position of FIG. 8.

It is to be noted that alternatively male cooperating members may be disposed on the support whereas female cooperating members may be disposed on the plate.

For instance, male blocking members may take the form of two protruding members disposed on two diametrically opposite sides of plate 74 as represented in FIG. 10 and which extend radially and outwardly from the outer periphery 118 of plate 74.

FIG. 11 is a back view (taken from left side in FIG. 7) showing portion 80 of holding element 72 and plate 74 accommodated in its housing and placed behind supporting portion 80.

The two protruding members (e.g. two indents) in each pair of protruding members 110, 112 and 114, 116 are angularly offset from each other and each pair is arranged within a recess provided on portion 80.

For example, each of the two recesses 120, 122 is radially and inwardly formed and has an angular extension greater than the angular space between two protruding members in each pair.

The angular extension of each recess is bounded by two radial edges denoted 120a and 120b for recess 120 and 122a and 122b for recess 122.

As represented in FIG. 12 which is a partial view in perspective of plate 74 disposed against portion 80, protruding member 112 comes into contact with edge 120b following a slight rotation of plate 74 within its housing. Edge 120b acts as a stop which prevents any further rotation in the direction of rotation R1.

Edge 120a illustrated in FIG. 11 acts in the same way with respect to protruding member 110 to block rotation of plate 74 in the opposite direction of rotation denoted R2.

Edges 120a and 120b within recess 120 (resp. edges 122a and 122b within recess 122) are female blocking members which mechanically cooperate with protruding members 110, 112 (resp. 114, 116).

The predetermined angular range around the predetermined angular position of plate 74 (magnitude of the rotation of plate 74) may be defined by the angular space between the two opposite edges in each recess and the angular offset between the two protruding members in each pair.

Other forms of male and female cooperating members may be envisaged to carry out the same above-mentioned function and possibly with an inverted disposition with respect to the plate and supporting portion.

For example, supporting portion 80 may be equipped with two diametrically opposite protruding members and plate 74 may be provided with two diametrically opposite recesses or grooves which have each an angular extension enabling limited rotation of plate 74 around the predetermined angular position (e.g. 45°).

1. A beverage machine comprising a casing enclosing:
a first part for receiving an ingredient capsule therein,
a second part having a surface comprising perforating projecting members facing the first part,
an opening in the casing allowing the ingredient capsule to be inserted in a direction of insertion between the first and second parts,
the first and second parts being movable relative to each other along a longitudinal axis perpendicular to the second part surface between two positions, a first position in which the first and second parts are spaced apart so that the ingredient capsule is inserted therebetween and a second position in which the first and second parts are close to each other so that the ingredient capsule received in the first part is in contact with the perforating projecting members, the insertion direction being substantially perpendicular to the longitudinal axis; and
the perforating projecting members are positioned with respect to the opening so as to reduce the risk of trapping of the ingredient capsule in a non-desired position by the perforating projecting members during the insertion of the ingredient capsule.

2. Beverage machine according to claim 1, wherein a space left open by the perforating projecting members on the surface is dimensioned and/or oriented so as to reduce the risk of trapping of the ingredient capsule by the perforating projecting members during the insertion of the ingredient capsule.

3. Beverage machine according to claim 1, wherein a space left open by the perforating projecting members is dimensioned in an orientation perpendicular to the insertion direction of the ingredient capsule so as to reduce the risk of trapping of the ingredient capsule by the perforating projecting members during the insertion of the ingredient capsule.

4. Beverage machine according to claim 1, wherein the perforating projecting members each have several perforating edges lying in a plane parallel to the surface of the second part, the perforating edges of the perforating projecting members which are oriented toward the opening being positioned at an angle to the insertion direction that is less than 90° when viewed in a plane where the perforating edges lie.

5. Beverage machine according to claim 4, wherein the angle is less than 75°.

6. Beverage machine according to claim 1, wherein the arrangement is in the form of a grid.

7. Beverage machine according to claim 1, wherein the perforating projecting members are truncated pyramids each extending from a base connected to the surface to a free end that has a squared surface defined by four linear perforating edges.

8. Beverage machine according to claim 1, wherein the second part comprises a plate having a surface provided with the perforating projecting members, and that is able to rotate about an axis perpendicular to the surface, the machine comprising a positioning member for positioning the surface in a predetermined angular position where the arrangement of the perforating projecting members allows a reduction of the risk of trapping of the ingredient capsule by the perforating projecting members during the insertion of the ingredient capsule.

9. Beverage machine according to claim 8, wherein the positioning member allows the surface to be slightly rotated around the predetermined angular position.

10. Beverage machine according to claim 8, wherein the plate is mounted against a support and the positioning member comprises male and female cooperating members on the support and the plate to prevent the plate from being significantly rotated from the predetermined angular position.

11. Beverage machine according to claim 1, wherein the part is selected among the first and second parts and is movable relative to the other part is displaced according to a rectilinear path along the longitudinal axis.

12. Beverage machine according to claim 1, wherein the first part that receives an ingredient capsule is moveable and the second part is in a fixed position.

13. A set comprising a beverage machine and an ingredient capsule having side and bottom walls defining a container that is filled with ingredients and closed by a closing member, the ingredient capsule having a flange extending laterally from side wall, the beverage machine comprising a casing enclosing:
a first part for receiving an ingredient capsule therein;
a second part having a surface that is provided with perforating projecting members facing the first part and having guiding members for guiding the ingredient capsule;
an opening in the casing allowing the ingredient capsule to be inserted in a direction of insertion between the first and second parts while the flange of the ingredient capsule is guided by the guiding members;
the first and second parts being movable relative to each other along a longitudinal axis perpendicular to the second part surface between two positions, a first position in which the first and second parts are spaced apart so that the ingredient capsule is inserted therebetween and a second position in which the first and second parts are close to each other so that the ingredient capsule received in the first part is in contact with the perforating projecting members, the insertion direction being substantially perpendicular to the longitudinal axis; and
the perforating projecting members are positioned in an arrangement on the surface of the second part with respect to the opening so as to reduce the risk of trapping of the flange of the ingredient capsule in a non-desired position by the perforating projecting members during the insertion of the ingredient capsule.
